(19) United States
(12) Patent Application Publication
(10) Pub. No.: US 2018/0017050 A1
(43) Pub. Date: Jan. 18, 2018

(54) Device and method for detecting an operating pressure of a fluid pump for a motor vehicle

(71) Applicant: CONTINENTAL AUTOMOTIVE GMBH, Hannover (DE)

(72) Inventors: Rolf GRAF, Glashuetten (DE); Gerald BEHRENDT, Frankfurt am Main (DE)

(21) Appl. No.: 15/522,566

(22) PCT Filed: Oct. 21, 2015
(86) PCT No.: PCT/EP2015/074408

§ 371 Date: Apr. 27, 2017

(30) Foreign Application Priority Data
Oct. 31, 2014 (DE) 10 2014 222 335.0

(51) Int. Cl. F04B 49/06; F04B 17/03; F02M 37/08; F04B 51/00

(52) U.S. Cl. CPC F04B 49/065; F04B 51/00; F04B 17/03; F02M 37/08; F04B 2203/0201; F04B 2203/0209

(57) ABSTRACT

A device for detecting an operating pressure of a fluid pump for a motor vehicle includes: a rotational speed detector configured to detect a rotational speed of the fluid pump; a pump current detector configured to detect at least one current of the fluid pump; a memory configured to store a pump current/rotational speed performance map with at least one pressure reference point; and a pressure determining device configured to determine a fluid pressure that prevails in the fluid pump based on the detected rotational speed, the detected current and the stored pump current/rotational speed performance map.

### CROSS-REFERENCE TO RELATED APPLICATIONS

This is a U.S. national stage of application No. PCT/EP2015/074408, filed on 21 Oct. 2015, which claims priority to the German Application No. 10 2014 222 335.0 filed 31 Oct. 2014, the content of both incorporated herein by reference.

### BACKGROUND OF THE INVENTION

### 1. Field of the Invention

The present invention relates to pressure regulation and limiting for fluid pumps. In particular, the present invention relates to a device and a method for detecting an operating pressure of a fluid pump for a motor vehicle.

### 2. Related Art

In modern motor vehicles or passenger cars, a sensor for the fluid pressure is often dispensed with for cost reasons. There is therefore no direct possibility for the engine control unit to extrapolate the actual state of the fuel supply system by way of a direct measurement of the fluid pressure and a comparison of the measured fluid pressure value with specified values, and optionally to avoid an overpressure or negative pressure by way of suitable measures.

### SUMMARY OF THE INVENTION

It is an object of the present invention to provide an improved device and an improved method for detecting an operating pressure of a fluid pump for a motor vehicle.

In accordance with a first aspect of the present invention, a device for detecting an operating pressure of a fluid pump for a motor vehicle includes: a rotational speed detector configured to detect a rotational speed of the fluid pump; a pump current detector configured to detect a current of the fluid pump; a memory configured to store a pump current/rotational speed performance map with at least one pressure reference point; and a pressure determining device configured to determine a fluid pressure that prevails in the fluid pump, based on the detected rotational speed, the detected current and the stored pump current/rotational speed performance map.

As used herein, the expression “current” also includes a pump current, as stored in the pump current/rotational speed performance map.

According to a further, second aspect, the present invention relates to a fluid pump for a motor vehicle, the fluid pump comprising a device according to the first aspect or according to any desired embodiment of the first aspect.

According to a further, third aspect, the present invention relates to a method for detecting an operating pressure of a fluid pump for a motor vehicle, the method includes: detecting a rotational speed of the fluid pump by a rotational speed detector; detecting a pump current of the fluid pump by a pump current detector; storing a pump current/rotational speed performance map with at least one or two pressure reference points in a memory; and determining a fluid pressure that prevails in the fluid pump, based on the detected rotational speed, the detected current and the stored pump current/rotational speed performance map by a pressure determining device.

Embodiments of the present invention advantageously make it possible to provide two or more additional reference points for the line current of a fluid pump at a known fluid pressure.

Embodiments of the present invention advantageously make it possible that a first additional reference point can be determined if the rotational speed of the pump is increased again, for example, by a precisely fixed value, after the opening point (for example, the point A) of a calibrating valve is reached.

Embodiment of the present invention advantageously make it possible, for example, to save and to store the rotational speed-dependent increase in the volumetric flow, that is to say the gradient of the delivery characteristic curve of the fluid pump, at a given pressure. The pressure regulator has, for example, a low and known, volumetric flow-dependent gradient, the pressure of the pressure regulator increasing with the volumetric flow. A known increase is then carried out in the volumetric flow by way of a rotational speed increase and can attribute the pump current, which is then determined to a defined fluid pressure.

In one advantageous embodiment of the present invention, the device has a regulator configured to provide pressure regulation for the fluid pump based on the determined fluid pressure.

In a further advantageous embodiment of the present invention, the device is configured to use a reference valve, in order to determine the at least one pressure reference point of the pump current/rotational speed performance map and to store it in the memory.

In one advantageous embodiment of the present invention, the device is configured to determine the at least one pressure reference point of the pump current/rotational speed performance map by a pressure increase.

It is provided in a further advantageous embodiment of the present invention that the device is configured to determine further pressure reference points of the pump current/rotational speed performance map and, furthermore, to determine a rotational speed-dependent increase in the volumetric flow of the fluid pump.

It is provided in a further advantageous embodiment of the present invention that the fluid pressure is determined based, furthermore, on a detected fuel temperature or a detected parameter which describes the fuel quality, or a detected fuel injection volume.

It is provided in a further advantageous embodiment of the present invention that the spread of the fluid pressure in the pump current/rotational speed performance map is determined utilizing, furthermore, an existing switching point of a pressure switch coupled to the fluid pump.

It is provided in a further advantageous embodiment of the present invention that the memory stores the pump current/rotational speed performance map with the spread of the fluid pressure.

The refinements and developments which are described can be combined with one another in any desired way.

Further possible refinements, developments and implementations of the present invention also comprise combinations which have not been explicitly mentioned of features of the invention which are described above or in the following text with regard to the exemplary embodiments.

### BRIEF DESCRIPTION OF THE DRAWINGS

The appended drawings are intended to impart further understanding of the embodiments of the present invention. The appended drawings illustrate embodiments and serve to explain concepts of the invention in conjunction with the description.

Other embodiments and many of the stated advantages arise with regard to the drawings. The illustrated elements of the drawings are not necessarily shown true to scale with respect to one another. In the drawings:

FIG. 1 shows a diagrammatic illustration of a device for detecting an operating pressure of a fluid pump in accordance with one embodiment of the present invention;

FIG. 2 shows a diagrammatic illustration of a flow chart of a method for detecting an operating pressure of a fluid pump for a motor vehicle in accordance with a further embodiment of the present invention;

FIG. 3 shows a diagrammatic illustration of a fluid pump for a motor vehicle in accordance with a further advantageous embodiment of the present invention;

FIG. 4 shows a diagrammatic illustration of a current consumption/rotational speed diagram for a fluid pump in order to explain the present invention;

FIG. 5 shows a diagrammatic illustration of a current consumption/rotational speed diagram of a fluid pump for a motor vehicle in order to explain the present invention, by way of example for a fuel pump;

FIG. 6 shows a diagrammatic illustration of a current consumption/rotational speed diagram of a fluid pump for a motor vehicle in order to explain the invention; and

FIG. 7 shows a diagrammatic illustration of a current consumption/rotational speed diagram of a fluid pump for a motor vehicle in order to explain the present invention.

### DETAILED DESCRIPTION OF THE PRESENTLY PREFERRED EMBODIMENTS

In the figures of the drawings, identical designations denote identical or functionally identical elements, parts, components or method steps, insofar as nothing to the contrary is specified.

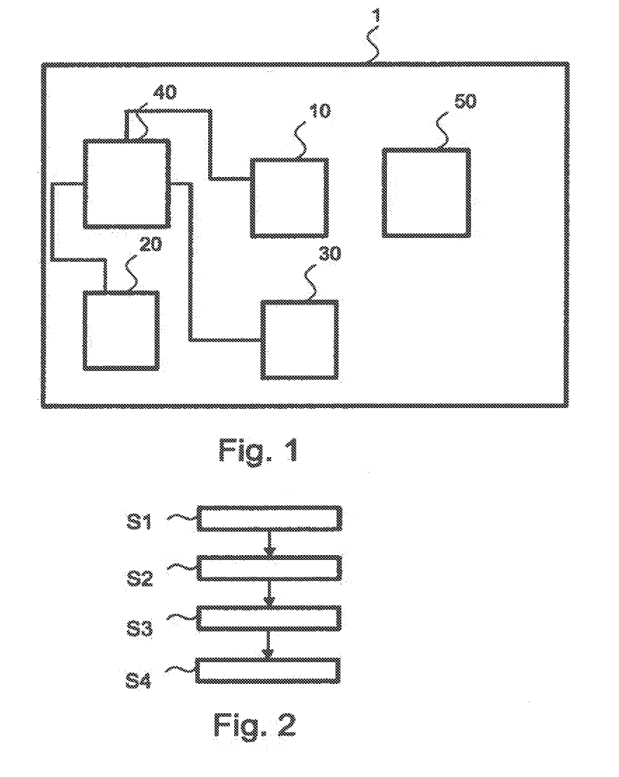

FIG. 1 shows a diagrammatic schematic illustration of a device for detecting an operating pressure of a fluid pump far a motor vehicle in accordance with one embodiment of the present invention.

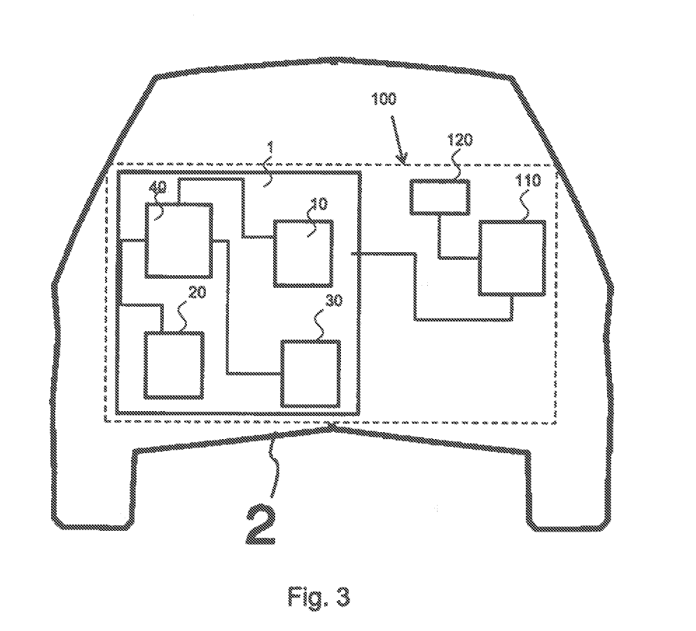

A device 1 for detecting an operating pressure of a fluid pump 100 for a motor vehicle 2 (see FIG. 3) comprises, for example, a rotational speed detector 10, a pump current detector 20, a memory 3D, a pressure determining device 40 and a regulator 50.

Furthermore, the regulator 50 can also be configured in a controller. Here, the regulator 50 can be connected to the device, for example, directly or, for example, via a vehicle bus system, for example a CAN bus.

The rotational speed detector 10 is configured, for example, to detect a rotational speed of the fluid pump 100 (see FIG. 3).

The pump current detector 20 is configured, for example, to detect a pump current of the fluid pump 100.

The memory 30 is configured, for example, to store a pump current/rotational speed performance map with at least one pressure reference point or with at least two pressure reference points.

The pressure determining device 40 is configured, for example, to determine a fluid pressure that prevails in the fluid pump 100, based on the detected rotational speed, the detected pump current and the stored pump current/rotational speed performance map.

The regulator 50 is configured, for example, to provide pressure regulation for the fluid pump 100 based on the determined fluid pressure.

FIG. 2 shows a diagrammatic illustration of a method for detecting an operating pressure of a fluid pump 100 for a motor vehicle 2.

The method comprises, for example, the following steps;

For example, detecting (S1) the rotational speed of the fluid pump 100 by a rotational speed detector 10 takes place as a first step of the method.

For example, detecting (S2) a pump current of the fluid pump 100 by a pump current detector 20 takes place as a second step of the method.

For example, storing (S3) a pump current/rotational speed performance map with at least one pressure reference point by a memory 30 takes place as a third step of the method.

For example, determining S4 a fluid pressure that prevails in the fluid pump 100 based on the detected rotational speed, the detected pump current and the stored pump current/rotational speed performance map by a pressure determining device 40 takes place as a fourth step of the method.

The following exemplary operating parameters prevail, for example:

An opening pressure of the reference valve lies, for example, at 8 bar, a pump current lies, for example, at 11 A, a volumetric flow that is conveyed to a following pump lies, for example, at 10 l/h, and a rotational speed of the fluid pump lies, for example, at approximately 3000 rpm.

Subsequently, for example, the rotational speed of the fluid pump is increased, for example, to 5000 rpm, the volumetric flow rises to 100 l/h, the opening pressure of the reference valve can then be calculated to 8.1 bar, and a pump current of 12 A is measured.

The gradient of the entire field plotted against the rotational speed can now be determined from these parameters. If the method is repeated with a plurality of rotational speeds in defined steps, a curvature of the current curves can also be determined. The pump current/rotational speed performance map can be oriented using the reference points.

FIG. 3 shows a diagrammatic illustration of a fluid pump in accordance with a further embodiment of the present invention.

A fluid pump 100 for a motor vehicle 2 comprises, for example, a device 1 as pump control electronics and an electric power machine 110. Furthermore, the fluid pump 100 comprises a mechanical pump stage 120 coupled via a shaft.

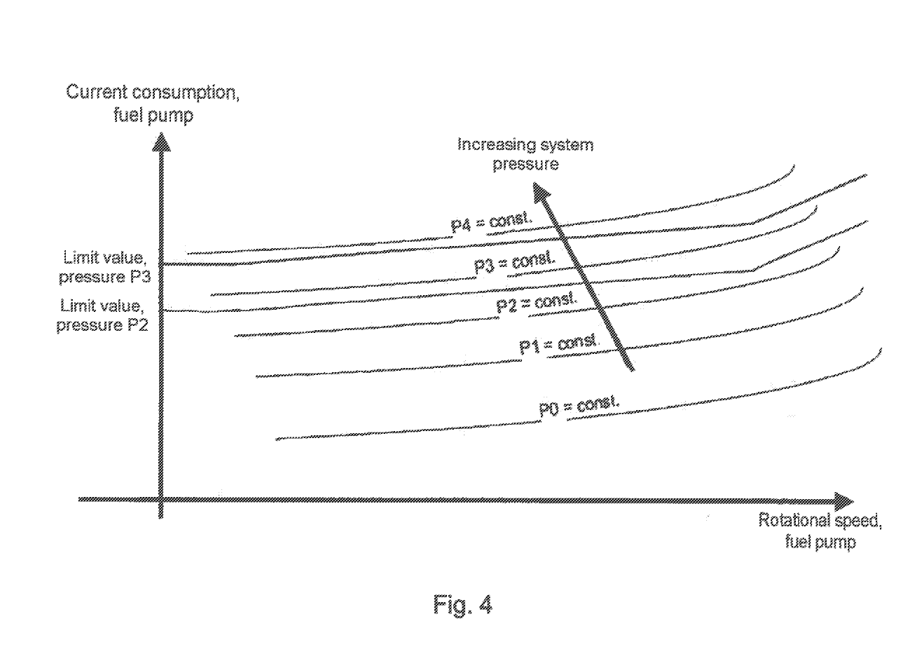

FIG. 4 shows a diagrammatic schematic illustration of a current consumption/rotational speed diagram in order to explain the invention.

FIG. 4 shows a diagrammatic schematic illustration of the current consumption of a fluid pump plotted against the rotational speed, in a manner dependent on the respective system pressure P0 to P4. Furthermore, FIG. 4 shows an exemplary illustration of the limit value curves P2 and P3, which are used, for example, for warning signals, that is to say a corresponding warning signal is effected if the system pressure is situated above the limit values that are considered to be permissible.

The parameter of the x-axis (denoted by “rotational speed, fuel pump”) might possibly also be replaced by pump voltage for pumps with brush motors, if no rotational speed determination is made via the commutator current ripple. A fluid pump can also be used instead of the fuel pump.

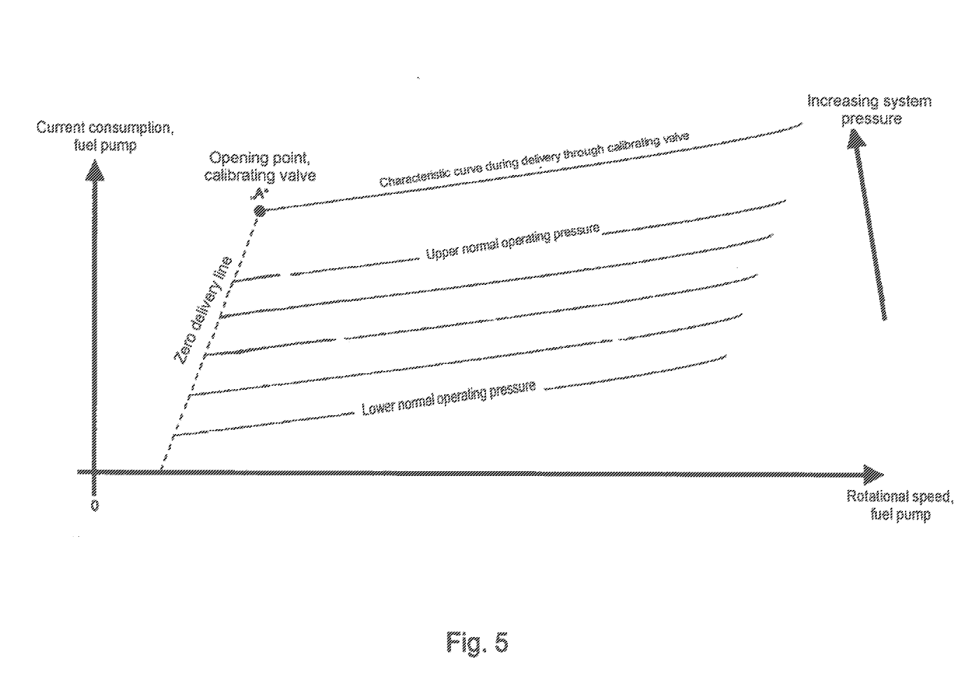

FIG. 5 shows a diagrammatic schematic illustration of the characteristic curve of the pump current plotted against the rotational speed if a reference valve is used. The opening point of the calibrating valve “A” is determined as a reference value in a known method and is used to improve the system accuracy.

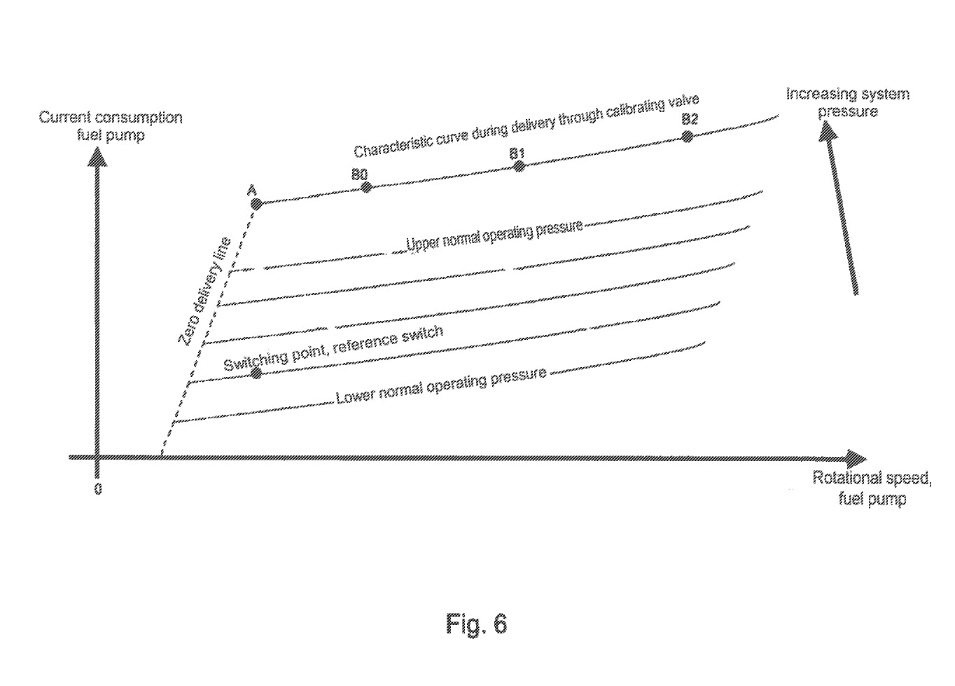

FIG. 6 shows a diagrammatic schematic illustration of the characteristic curve of the pump current plotted against the rotational speed if a reference valve is used. The opening point of the calibrating valve “A” is determined as a reference value in a known method. The additional determination and advantageous use of the points B0, B2, B2 and further points is made possible by way of the present invention. The point C0 is determined by way of the switching of a pressure switch, as likewise used advantageously by the present invention, as clarified by way of the designation “switching point, reference switch”.

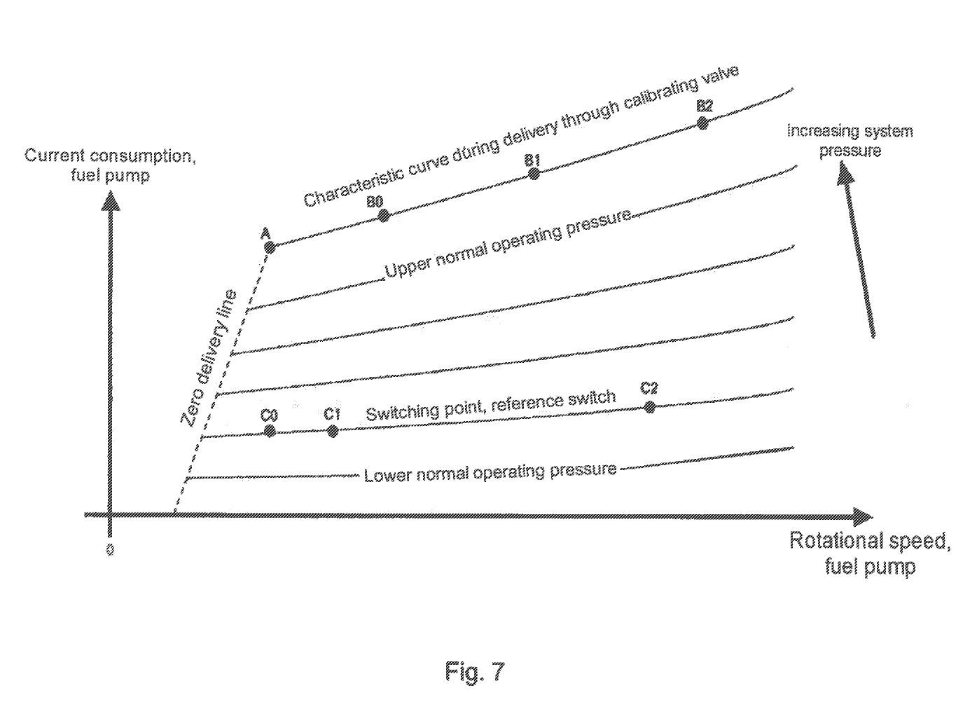

FIG. 7 shows a diagrammatic schematic illustration of the characteristic curve of the pump current plotted against the rotational speed with an illustration of a spread of the performance map as a result of an influence of viscosity. The points C1, C2 have been determined by way of switching of the pressure switch at a switching pressure, but at different rotational speeds or delivery capacities of the fluid pump. Further points can likewise be determined by way of switching points of further switches.

The present invention advantageously makes it possible to determine the gradient of the performance map plotted against pressure, that is to say current change plotted against pressure change, by way of determination of a further reference point.

For example, an inexpensive pressure switch is suitable for this purpose, which pressure switch closes at a defined pressure in the operating range and therefore permits continuous tracking of the characteristic diagram expansion.

The present invention advantageously makes it possible if the pressure switch switches at a pressure that can also be attained during normal operation of the motor vehicle at any time and in an arbitrary manner by way of the pump controller or by way of the engine controller.

For example, the operating pressure in a motor vehicle can reach from 2 to 7 bar, and the core operating region can reach from 3 to 6 bar.

During normal operation, an operating pressure of 3 bar is usually provided for the fluid pump for energy reasons.

At increased ambient temperatures, the system pressure is increased, for example, to 6 bar.

If the pressure switch is set to 4 bar, this switching point can be attained at most times of normal operation in a cyclical/periodical manner for referencing purposes, without the driving performance or the emission of carbon dioxide being influenced.

Although the present invention has been described in the above text using preferred exemplary embodiments, it is not restricted thereto, but rather can be modified in a wide variety of ways. In particular, the present invention can be changed or modified in various ways, without departing from the core concept of the invention.

In addition, it is to be noted that “comprising” and “having” do not rule out any other elements or steps, and “a” or “one” do not rule out a multiplicity.

Furthermore, it is to be noted that features or steps which have been described with reference to one of the above exemplary embodiments can also be used in combination with other features or steps of other above-described exemplary embodiments.

Reference numbers in the claims are not to be considered to be restrictions.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A device (1) for detecting an operating pressure of a fluid pump (100) for a motor vehicle, the device comprising:
a rotational speed defector (10) configured to detect a rotational speed of the fluid pump (100);
a pump current detector (20) configured to detect at least one current of the fluid pump (100);
a memory (30) configured to store a pump current/rotational speed performance map with at least one pressure reference point; and
a pressure determining device (40) configured to determine a fluid pressure that prevails in the fluid pump (100) based on the detected rotational speed, the detected current and the stored pump current/rotational speed performance map.

12. The device as claimed in claim 11, the device (1), further comprising a regulator (50) configured to provide a pressure regulation for the fluid pump (100) based on the determined fluid pressure.

13. The device as claimed in claim 11, the device (1) being configured to use a reference valve to determine the at least one pressure reference point of the pump current/rotational speed performance map and to store it in the memory (30).

14. The device as claimed in claim 11, the device (1) being configured to determine the at least one pressure reference point of the pump current/rotational speed performance map by a pressure increase.

151. The device as claimed in claim 11, the device (1) being configured to determine further pressure reference points of the pump current/rotational speed performance map and to determine a rotational speed-dependent increase in the volumetric flow of the fluid pump.

16. The device as claimed in claim 11, the pressure determining device (40) being configured to determine the fluid pressure based on a detected fuel temperature, a detected parameter which describes the fuel quality, and a detected fuel injection volume.

17. The device as claimed in claim 11, the pressure determining device (40) being configured to determine a spread of the fluid pressure in the pump current/rotational speed performance map utilizing an existing switching point of a pressure switch which is coupled to the fluid pump.

18. The device as claimed in claim 17, the memory (30) being configured to store the pump current/rotational speed performance map with the spread of the fluid pressure.

19. A fluid pump (100) for a motor vehicle (2), the fluid pump (100) comprising a devise (1) as claimed in claim 11.

20. A method for detecting an operating pressure of a fluid pump (100) for a motor vehicle, the method comprising:
detecting (S1) a rotational speed of the fluid pump (100) by a rotational speed detector (10);
detecting (S2) a current of the fluid pump (100) by a pump current detector (20);
storing (S3) a pump current/rotational speed performance map with at least one pressure reference point by a memory (30); and
determining (S4) a fluid pressure that prevails in the fluid pump (100), based on the detected rotational speed, the detected current and the stored pump current/rotational speed performance map, by a pressure determining device (40).
